(19) United States
(12) Patent Application Publication
(10) Pub. No.: US 2011/0118393 A1
(43) Pub. Date: May 19, 2011

(54) SURGE-RESISTANT AND ABRASION-RESISTANT FLEXIBLE INSULATING ENAMEL

(75) Inventors: Wei-Jung YEN, KUANIN TOWNSHIP (TW); Wei-Chih YANG, KUANIN TOWNSHIP (TW); Chun-Yu HUANG, KUANIN TOWNSHIP (TW)

(73) Assignee: FU PAO CHEMICAL CO., LTD., KUANIN TOWNSHIP (TW)

(21) Appl. No.: 12/705,507

(22) Filed: Feb. 12, 2010

(30) Foreign Application Priority Data
Nov. 19, 2009 (TW) 098139280

(51) Int. Cl. C08K 5/3415; C08K 5/20; C08K 5/10; C08K 5/13; C08K 5/07; C08K 9/04; C08K 3/34

(52) U.S. Cl. 524/104; 524/233; 524/284; 524/352; 524/356; 524/445; 524/449

(57) ABSTRACT

A surge-resistant and abrasion resistant flexible insulating enamel has resin in an amount of 12 wt % to 76 wt % per 100 wt % by weight of the enamel, an organic solvent in an amount of 20 wt % to 80 wt % per 100 wt % by weight of the enamel, polyethylene oxide (PEO) intercalated clay in an amount of 0.005 wt % to 16 wt % per 100 wt % by weight of the enamel, and organic dispersible silica nano-particles in an amount of 0.995 wt % to 16 wt % per 100 wt % by weight of the enamel. The clay and silica nano-particles have high dielectric constant to absorb, disperse evenly and evacuate surge, which prevents an insulating layer made by the insulating enamel from being damaged from the surge. PEO provides the insulating layer has good flexibility, adhesion and abrasion resistance.

### BACKGROUND OF THE INVENTION

1. Field of Invention

The present invention relates to an insulating enamel and more particularly to a surge-resistant insulating enamel with excellent abrasion resistance and flexibility for application to a conductor to form an enameled wire.

2. Description of the Related Art

Recent environmental events have encouraged many countries to save energy and reduce CO₂ output. Therefore, several protocols and strategies have been established, including, energy-saving inverters. Inverters control the rotation speed of the motor by changing voltage and frequency. Therefore, the motor has improved loading and drive efficiencies. Accordingly, regenerative power can be used for a motor with the inverter due to the inverter saves energy.

Inverters can also be applied to various other systems, including, intelligent power modules (IPMs) using the inverter due to its small size and reduced cost. Furthermore, multiple inverters may be connected to each other to form an inverter network for building remote control and maintenance system or the like.

Power stations transmit electricity with normal voltage (110 volt). A surge is when transient voltage is higher than the normal voltage. The surge can be observed in an oscilloscope, which presents an abnormally high and abrupt pulse among a serious of stable pulses that also means voltage level or current changes suddenly during a serious of stable signals. Reasons for generation of surge, for example, include lightning, breakdown of power system or the like. Although the power station has protection mechanism, some surges may be still transmitted because the protection mechanism has a limit. Furthermore, the protection mechanism may generate a surge, such as, a switch in a house being turned on or off. Sometimes, the surge may destroy electronic devices such as computers, televisions, stereos or the like since their resistant ability against surge is insufficient.

An inverter itself also generates surges. When the inverter drives a motor, the inverters generates pulse current, called “inverter surge”, may damage insulating properties of enameled wire around the motor and interrupt magnetic field of motor, relay, transformer or the like. Generally speaking, surge applies extremely huge loading to the enameled wire. If the enameled wire insulating material does not have sufficient insulating strength or cannot evacuate the loading, an insulating layer is easily broken or destroyed, so a coil wound by the enameled wire may cause short-circuit or transmit unstably, and then the electronic devices cannot be used normally or are damaged. Even surge absorber cannot dissolve above problems thoroughly. Therefore, insulating material for enameled wire with surge resistance is the key to developing inverters.

For satisfying above demand, some surge-resistant insulating materials were developed. In 1985, General Electric Company (U.S. Pat. No. 4,493,873) published a surge-resistant insulating enamel for forming an insulating layer including metal such as alumina. In 1997, Phelps Dodge Industries, Inc. (U.S. Pat. No. 5,654,095) published a surge-resistant insulating enamel for forming an insulating layer including metallic oxides such as TiO₂, Al₂O₃, Cr₂O₃, ZnO, or the like. Owing to high dielectric constant of the metallic oxides, the metallic oxides are able to absorb, disperse or evacuate surge, so the insulating layer will not be damaged. For further avoiding damage from surge, multiple layers of coating are applied to an enameled wire. For example, a conductor is coated with a surge-resistant insulating enamel and then is coated with an organic insulating protective coating, so the organic insulating protective coating is able to offset the surge after the surge penetrates the surge-resistant insulating layer. Interface compatibility between the metallic oxides and organic insulating materials is important. If interface compatibility between them is poor, the metallic oxides agglomerate easily to form particles with large sizes. Hence, the metallic oxides are distributed heterogeneously, which lowers dispersion and evacuation of surge.

Inorganic material, such as silica, efficiently prevents the enameled wire in a motor from damage by surge generated from corona discharge. Organic insulating material added with inorganic material enhances surge-resistance of the insulating layer. However, inorganic material is not soft enough. If inorganic material is distributed heterogeneously, stress occurs in the enameled wire when the enameled wire is wound into a coil, so electrical and mechanical defaults will damage the enameled wire. Apparently, how to distribute inorganic material homogeneously is a major problem.

In addition to metallic oxides or nano organic silica particles, inorganic material with layer structure can also be added into insulating layer. JP utility model No. S59-176363, JP patent No. 2005-190699, U.S. Pat. Nos. 4,476,192, 5,654,095, 6,906,258 and 2005-0142349 disclose that inorganic material with layer structure improves withstand pot life of enameled wire for resisting surge. The inorganic material may be modified. As mentioned in the above patents, the inorganic material has a layer structure in which the silicate layers and adjacent layers intercalated by quaternary ammonium salts or quaternary phosphonium salts. Unfortunately, the quaternary ammonium or phosphonium salts may affect the crosslinking density of the insulating polymer, and then results in the brittle insulating layer peeling off from the conductor.

To overcome the shortcomings, the present invention provides a surge-resistant and abrasion resistant flexible insulating enamel to mitigate or obviate the aforementioned.

### SUMMARY OF THE INVENTION

The primary objective of the present invention is to provide a surge-resistant insulating enamel with excellent abrasion resistance and flexibility for being applied to a conductor to form an enameled wire.

To achieve the objective, a surge-resistant and abrasion resistant flexible insulating enamel in accordance with the present invention comprises resin in an amount of 12 wt % to 76 wt % per 100 wt % by weight of the enamel, an organic solvent in an amount of 20 wt % to 80 wt % per 100 wt % by weight of the enamel, polyethylene oxide (PEO) intercalated clay in an amount of 0.005 wt % to 16 wt % per 100 wt % by weight of the enamel, and organic dispersible silica nano-particles in an amount of 0.995 wt % to 16 wt % per 100 wt % by weight of the enamel.

The clay and silica nano-particles have high dielectric constant that can absorb, disperse evenly and evacuate surge, which prevents an insulating layer made by the insulating enamel of the present invention from being damaged from the surge. Furthermore, PEO is flexible, facilitates the clay to distribute uniformly into the resin and can be bond with the resin, so the insulating layer has good flexibility, adhesion and abrasion resistance.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of a method for manufacturing a surge-resistant and abrasion resistant flexible insulating enamel in accordance with the present invention.

### DETAILED DESCRIPTION OF THE INVENTION

A surge-resistant and abrasion resistant flexible insulating enamel in accordance with the present invention comprises resin, an organic solvent, polyethylene oxide (PEO) intercalated clay, and organic dispersible silica nano-particles.

The resin is in an amount of 12 wt % to 76 wt % per 100 wt % by weight of the enamel. The resin is selected from the group consisting of polyamideimides (PAI), polyetherimides (PEI), polyesterimides, polyimides, polyamides, polyesters, polyurethanes, epoxies, phenolics, phenoxy, polyvinyl fluoride (PVF) and polyvinyl butyral (PVB).

The organic solvent is in an amount of 20 wt % to 80 wt % per 100 wt % by weight of the enamel. The organic solvent is selected from the group consisting of phenol, hydrocarbon solvent, benzene, ester, ketone and a mixture thereof. More preferably, the organic solvent is selected from the group consisting of cresol, dimethyl phenol, toluene, xylene, ethylbenzene, N,N-dimethylformamide (DMF), N-methylpyrrolidone (NMP) and a mixture thereof.

The PEO intercalated clay is in an amount of 0.005 wt % to 16 wt % per 100 wt % by weight of the enamel and has clay and PEO intercalation reagent intercalated in the clay. The clay is selected from the group consisting of smectites, micas and vermiculite. The smectites are selected from the group consisting of montmorillonite, hectorite, laponite, saponite, sauconite, beidellite, stevensite and nontronite. The micas are selected from the group consisting of chlorite, phlogopite, lepidolite, muscovite, biotite, paragonite, margarite, taeniolite and tetrasilicic mica. Molecular weight of PEO is between 600 and 1,000,000. A weight proportion of the PEO intercalation reagent and clay is from 20:80 to 45:55. Preferably, the clay has an average particle size smaller than 20 μm.

The organic dispersible silica nano-particles are in an amount of 0.995 wt % to 16 wt % per 100 wt % by weight of the enamel. Preferably, the organic dispersible silica nano-particles have an average size smaller than 50 nm.

A proportion of the PEO intercalated clay and the organic dispersible silica nano-particles is from 0.5:99.5 to 50:50.

A proportion of resin and a combination including the PEO intercalated clay and the organic dispersible silica nano-particles is from 95:5 to 60:40. Preferably, a proportion of resin and a combination including the PEO intercalated clay and the organic dispersible silica nano-particles is from 90:10 to 70:30. More preferably, a proportion of resin and a combination including the PEO intercalated clay and the organic dispersible silica nano-particles is from 80:20 to 75:25.

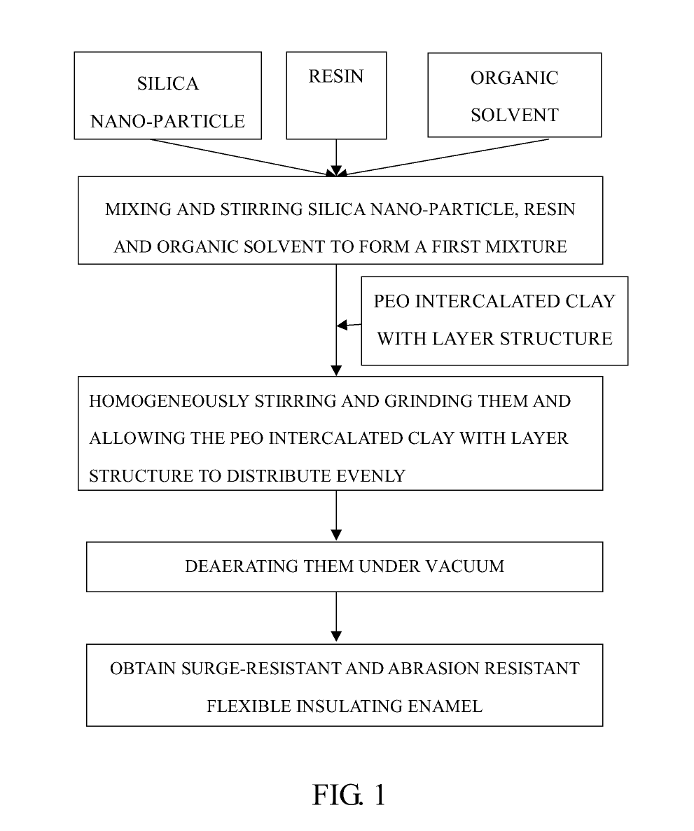

With reference to FIG. 1, a method for manufacturing the surge-resistant and abrasion resistant flexible insulating enamel in accordance with the present invention comprises mixing resin, organic solvent and organic dispersible silica nano-particles to form a first mixture; adding PEO intercalated clay into the first mixture to form a second mixture; homogeneously stirring and grinding the second mixture allowing the PEO intercalated clay to distribute evenly; and deaerating the second mixture under vacuum for 30 minutes to obtain the surge-resistant and abrasion resistant flexible insulating enamel.

The surge-resistant and abrasion resistant flexible insulating enamel of the present invention is used to apply around a conductor and is dried to form an insulating layer.

The surge-resistant and abrasion resistant flexible insulating enamel of the present invention contains non-metallic inorganic material including clay (a kind of silicate) and silica nano-particles (a kind of oxide), which has high dielectric constant, excellent strength, hardness, insulation, thermal conductivity, high-temperature resistance, oxidation resistance, corrosion resistance, abrasion resistance and high temperature strength.

Those materials with high dielectric constant can absorb, disperse evenly and evacuate surge (such as effect of electric capacity), which prevents the insulating layer of the present invention from being damaged from the surge.

PEO hydroxyl group can be bond with resin and then exfoliate clay to distribute uniformly into the resin. And, the structure of PEO is soft to improve the flexibility of the insulating layer. Therefor, each insulating layer has good flexibility, adhesion and abrasion resistance.

### EXAMPLE

Several examples of the present invention and competitive examples show compositions of coatings of insulating layers of the present invention and that of comparative coatings of insulating layers, which are shown in Table 1.

TABLE 1

| | | PEO | | | | |
|---|---|---|---|---|---|---|
| | Resin/Solid | intercalated | PEO | Clay | SiO₂ | Resin |
| | Content (g) | clay (g) | (g) | (g/wt %) | (g/wt %) | (wt %) |
| Ex. 1 | PEI/380 | 10 | 3 | 7/1.75 | 10/2.5 | 95 |
| Ex. 2 | PEI/320 | 0.4 | 0.12 | 0.28/0.07 | 79.6/19.9 | 80 |
| Ex. 3 | PEI/300 | 40 | 12 | 28/7 | 60/15 | 75 |
| Ex. 4 | PAI/240 | 30 | 9 | 21/7 | 30/10 | 80 |
| Ex. 5 | PEI/320 | 32 | 9.6 | 22.4/5.6 | 48/12 | 80 |
| Ex. 6 | PEI/320 | 32 | 14.4 | 17.6/4.4 | 48/12 | 80 |
| | | quaternary | | | | |
| | | ammonium salts | quaternary | | | |
| | Resin/Solid | intercalated | ammonium | Clay | SiO₂ | Resin |
| | Content (g) | clay (g) | salts (g) | (g/wt %) | (g) | (wt %) |
| Comp. | PEI/360 | 40 | 12 | 28/7 | 0/0 | 90 |
| Ex. 1 | | | | | | |
| Comp. | PEI/280 | 48 | 14.4 | 33.6/8.4 | 72/18 | 70 |
| Ex. 2 | | | | | | |
| Comp. | PAI/300 | 0 | 0 | 0/0 | 0/0 | 100 |
| Ex. 3 | | | | | | |

### Example 1

950 g polyetherimide (PEI) solution (solid content: 40%, organic solution including 470 g cresol, 70 g NMP, 30 g xylene) and 10.0 g silica (SiO₂) nano-particles were poured into a 1000-ml beaker and were stirred with high speed under room temperature for 30 minutes. 10.0 g PEO intercalated clay (Laponite RDS) was added into the 1000-ml beaker, wherein molecular weight of PEO is 100,000, a proportion of PEO and clay is 30:70. After being ground and dispersed, a mixture in the 1000-ml beaker was deaerated under vacuum for 30 minutes to obtain a surge-resistant and abrasion resistant flexible insulating enamel of the present invention.

### Example 2

800 g polyetherimide (PEI) solution (solid content: 40%, organic solution including 380 g cresol, 70 g NMP, 30 g xylene) and 79.6 g silica (SiO₂) nano-particles were poured into a 1000-ml beaker and were stirred with high speed under room temperature for 30 minutes. 0.4 g PEO intercalated clay (Laponite RDS) was added into the 1000-ml beaker, wherein molecular weight of PEO is 100,000, a proportion of PEO and clay is 30:70. After being ground and dispersed, a mixture in the 1000-ml beaker was deaerated under vacuum for 30 minutes to obtain a surge-resistant and abrasion resistant flexible insulating enamel of the present invention.

### Example 3

750 g polyetherimide (PEI) solution (solid content: 40%, organic solution including 350 g cresol, 70 g NMP, 30 g xylene) and 60.0 g silica (SiO₂) nano-particles were poured into a 1000-ml beaker and were stirred with high speed under room temperature for 30 minutes. 40.0 g PEO intercalated clay (Laponite RDS) was added into the 1000-ml beaker, wherein molecular weight of PEO is 100,000, a proportion of PEO and clay is 30:70. After being ground and dispersed, a mixture in the 1000-ml beaker was deaerated under vacuum for 30 minutes to obtain a surge-resistant and abrasion resistant flexible insulating enamel of the present invention.

### Example 4

800 g polyamideimide (PAI) solution (solid content: 30%, organic solution including 460 g cresol, 70 g NMP, 30 g xylene) and 30.0 g silica (SiO₂) nano-particles were poured into a 1000-ml beaker and were stirred with high speed under room temperature for 30 minutes. 30.0 g PEO intercalated clay (Laponite RDS) was added into the 1000-ml beaker, wherein molecular weight of PEO is 100,000, a proportion of PEO and clay is 30:70. After being ground and dispersed, a mixture in the 1000-ml beaker was deaerated under vacuum for 30 minutes to obtain a surge-resistant and abrasion resistant flexible insulating enamel of the present invention.

### Example 5

800 g polyetherimide (PEI) solution (solid content: 40%, organic solution including 320 g cresol, 70 g NMP, 30 g xylene) and 48.0 g silica (SiO₂) nano-particles were poured into a 1000-ml beaker and were stirred with high speed under room temperature for 30 minutes. 32.0 g PEO intercalated clay (Laponite RDS) was added into the 1000-ml beaker, wherein molecular weight of PEO is 6,000, a proportion of PEO and clay is 30:70. After being ground and dispersed, a mixture in the 1000-ml beaker was deaerated under vacuum for 30 minutes to obtain a surge-resistant and abrasion resistant flexible insulating enamel of the present invention.

### Example 6

800 g polyetherimide (PEI) solution (solid content: 40%, organic solution including 320 g cresol, 70 g NMP, 30 g xylene) and 48.0 g silica (SiO₂) nano-particles were poured into a 1000-ml beaker and were stirred with high speed under room temperature for 30 minutes. 32.0 g PEO intercalated clay (Laponite RDS) was added into the 1000-ml beaker, wherein molecular weight of PEO is 100,000, a proportion of PEO and clay is 45:55. After being ground and dispersed, a mixture in the 1000-ml beaker was deaerated under vacuum for 30 minutes to obtain a surge-resistant and abrasion resistant flexible insulating enamel of the present invention.

### Comparative Example 1

900 g polyetherimide (PEI) solution (solid content: 40%, organic solution including 440 g cresol, 70 g NMP, 30 g xylene) and 40.0 g quaternary ammonium salts intercalated clay (Cloisite® 30B) were poured into a 1000-ml beaker and were stirred with high speed under room temperature for 30 minutes. After being ground and dispersed, a mixture in the 1000-ml beaker was deaerated under vacuum for 30 minutes to obtain a comparative insulating enamel.

### Comparative Example 2

700 g polyetherimide (PEI) solution (solid content: 40%, organic solution including 320 g cresol, 70 g NMP, 30 g xylene) and 72.0 g silica (SiO₂) nano-particles were poured into a 1000-ml beaker and were stirred with high speed under room temperature for 30 minutes. 48.0 g quaternary ammonium salts intercalated clay (Cloisite® 30B) was added into the 1000-ml beaker. After being ground and dispersed, a mixture in the 1000-ml beaker was deaerated under vacuum for 30 minutes to obtain a comparative insulating coating enamel.

### Comparative Example 3

Polyamideimide (PAI) (solid content: 40%) was deaerated under vacuum for 30 minutes to obtain a comparative insulating enamel.

The coating of each example or comparative example was coated around a conductor with any conventional procedure depending on viscosity of the coating, such as using dies, rollers, felt or other method that can be known by the person with ordinary skilled in the art. The coating was coated around the conductor with a coating line-speed between 3 and 150 meters per minute. After the conductor was coated with the coating each time, the coating was dried and cured with conventional oven. Temperature of the oven was controlled depending on composition of the coating, size of the oven, thickness of an insulating layer or the like.

In these examples and comparative examples, each coating was coated around a copper conductor with diameter of 1.024 mm, then was dried and cured in an oven with an input temperature between about 300 and 350° C. and an output temperature between about 350 and 700° C. to form an enameled wire with an insulating layer that has a thickness of 25 μm.

The enameled wires of the foregoing examples and comparative examples underwent tests to obtain their properties including flexibility, adhesion, thermal shock, breakdown voltage, elongation, softening temperature, abrasion assistance, and pot life of surge resistance. The test for determining the pot life of surge resistance of each enameled wire included providing 13 N loading into enameled wire, twisting the enameled wire eight time to obtain a bunch wire, putting the bunch wire in an oven (190° C.) of a surge-testing machine and turning on the surge-testing machine (440V, 30 Hz, surge: 1.2 KV↑) for measuring the pot life of surge resistance. Other test was undergone according to American National Standard for Electrical Power Insulators (NEMA) 1000 PART 3. The results of the enameled wires of the examples and comparative examples are shown in Table 2.

TABLE 2

| | | | | breakdown | | softening | abrasion | pot life |
|---|---|---|---|---|---|---|---|---|
| | | | thermal | voltage | elongation | temperature | resistance | of surge |
| | flexibility | adhesion | shock | (KV) | (%) | (° C.) | (g) | resistance (H) |
| ex. 1 | good | good | good | 14.2 | 37.5 | 378 | 1835 | 166 |
| ex. 2 | good | good | good | 13.6 | 36.8 | 374 | 1880 | 380 |
| ex. 3 | good | good | good | 13.2 | 36.1 | 370 | 1900 | 425 |
| ex. 4 | good | good | good | 14.0 | 39.0 | 386 | 2050 | 450 |
| ex. 5 | good | good | good | 13.3 | 36.6 | 373 | 1890 | 410 |
| ex. 6 | good | good | good | 13.3 | 36.6 | 373 | 1870 | 410 |
| comp. | poor | poor | poor | 12.6 | 35.0 | 355 | 1750 | 110 |
| ex. 1 | | | | | | | | |
| comp. | bad | bad | bad | 11.8 | 30.5 | 320 | 1660 | 186 |
| ex. 2 | | | | | | | | |
| comp. | good | good | good | 14.5 | 40.0 | 390 | 1950 | 10 |
| ex. 3 | | | | | | | | |

No any inorganic material was added in the coating of the comparative example 3, so the insulating layer had good flexibility, adhesion and thermal shock properties, however, it had lower pot life of surge resistance (only 10 hours).

Quaternary ammonium salts intercalated clay was added in the coating of the comparative example 1, so the pot life of surge resistance of the insulating layer was increased to 110 hours. However, the quaternary ammonium salts affect the crosslinking density of the insulating polymer during the coating was dried and cured, and then results in the brittle insulating layer. Accordingly, properties including flexibility, adhesion and thermal shock were poor.

Both quaternary ammonium salts intercalated clay and silica nano-particles were added in the coating of the comparative example 2, so the pot life of surge resistance of the insulating layer reached to 186 hours. However, properties including flexibility, adhesion and thermal shock became bad.

In the above cases, clay and silica nano-particles were proved for elongating the pot life of surge resistance of the insulating layer.

Regarding example 1 of the present invention, the content of PEO intercalated clay and silica nano-particles was lowest in all examples of the present invention. A ratio of resin and a combination of PEO intercalated clay and silica nano-particles was 95:5, so the pot life of surge resistance of the insulating layer was 166 hours, which was higher than that of the comparative example 1 and 3 and close to that of the comparative example 2.

While the content of PEO intercalated clay and silica nano-particles increased, the pot life of surge resistance of the insulating layers were increased to 380 to 450 hours, wherein ratios of resin and a combination of PEO intercalated clay and silica nano-particles in examples 2 to 6 were from 80:20 to 75:25. The pot lives of surge resistance of the insulating layers in examples 2 to 6 were far beyond that in each comparative example.

Furthermore, PEO can be bond with resin and then exfoliate clay to distribute uniformly into the resin. And, the structure of PEO is soft to improve the flexibility of the insulating layer. Therefor, each insulating layer in all examples of the present invention had good flexibility, adhesion and thermal shock and had better break-down voltage, elongation, softening temperature and abrasion resistance than comparative examples 1 and 2.

Accordingly, the insulating enamel of the present invention was proved to have surge resistance, abrasion resistance and flexibility.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A surge-resistant and abrasion resistant flexible insulating enamel comprising:
resin in an amount of 12 wt % to 76 wt % per 100 wt % by weight of the enamel;
an organic solvent in an amount of 20 wt % to 80 wt % per 100 wt % by weight of the enamel;
polyethylene oxide (PEO) intercalated clay in an amount of 0.005 wt % to 16 wt % per 100 wt % by weight of the enamel; and
organic dispersible silica nano-particles in an amount of 0.995 wt % to 16 wt % per 100 wt % by weight of the enamel.

2. The insulating enamel as claimed in claim 1, wherein the resin is selected from the group consisting of polyamideimides (PAI), polyetherimides (PEI), polyesterimides, polyimides, polyamides, polyesters, polyurethanes, epoxies, phenolics, phenoxy, polyvinyl fluoride (PVF) and polyvinyl butyral (PVB).

3. The insulating enamel as claimed in claim 1, wherein the PEO intercalated clay has clay and PEO intercalation reagent intercalated in the clay and the clay is selected from the group consisting of smectites, micas and vermiculite, wherein the smectites are selected from the group consisting of montmorillonite, hectorite, laponite, saponite, sauconite, beidellite, stevensite and nontronite; and the micas are selected from the group consisting of chlorite, phlogopite, lepidolite, muscovite, biotite, paragonite, margarite, taeniolite and tetrasilicic mica.

4. The insulating enamel as claimed in claim 2, wherein the PEO intercalated clay has clay and PEO intercalation reagent intercalated in the clay and the clay is selected from the group consisting of smectites, micas and vermiculite, wherein the smectites are selected from the group consisting of montmorillonite, hectorite, laponite, saponite, sauconite, beidellite, stevensite and nontronite; and the micas are selected from the group consisting of chlorite, phlogopite, lepidolite, muscovite, biotite, paragonite, margarite, taeniolite and tetrasilicic mica.

5. The insulating enamel as claimed in claim 1, wherein the organic solvent is selected from the group consisting of phenol, hydrocarbon solvent, benzene, ester, ketone and a mixture thereof.

6. The insulating enamel as claimed in claim 4, wherein the organic solvent is selected from the group consisting of phenol, hydrocarbon solvent, benzene, ester, ketone and a mixture thereof.

7. The insulating enamel as claimed in claim 5, wherein the organic solvent is selected from the group consisting of cresol, dimethyl phenol, toluene, xylene, ethylbenzene, N,N-dimethylformamide (DMF), N-methylpyrrolidone (NMP) and a mixture thereof.

8. The insulating enamel as claimed in claim 6, wherein the organic solvent is selected from the group consisting of cresol, dimethyl phenol, toluene, xylene, ethylbenzene, N,N-dimethylformamide (DMF), N-methylpyrrolidone (NMP) and a mixture thereof.

9. The insulating enamel as claimed in claim 1, wherein a weight proportion of the PEO intercalation reagent and clay is from 20:80 to 45:55.

10. The insulating enamel as claimed in claim 8, wherein a weight proportion of the PEO intercalation reagent and clay is from 20:80 to 45:55.

11. The insulating enamel as claimed in claim 1, wherein a proportion of resin and a combination including the PEO intercalated clay and the organic dispersible silica nano-particles is from 95:5 to 60:40.

12. The insulating enamel as claimed in claim 10, wherein a proportion of resin and a combination including the PEO intercalated clay and the organic dispersible silica nano-particles is from 95:5 to 60:40.

13. The insulating enamel as claimed in claim 1, preferably, wherein a proportion of resin and a combination including the PEO intercalated clay and the organic dispersible silica nano-particles is from 90:10 to 70:30.

14. The insulating enamel as claimed in claim 10, preferably, wherein a proportion of resin and a combination including the PEO intercalated clay and the organic dispersible silica nano-particles is from 90:10 to 70:30.

15. The insulating coating as claimed in claim 1, wherein a proportion of resin and a combination including the PEO intercalated clay with layer structure and the organic dispersible silica nano-particles is from 80:20 to 75:25.

16. The insulating coating as claimed in claim 10, wherein a proportion of resin and a combination including the PEO intercalated clay with layer structure and the organic dispersible silica nano-particles is from 80:20 to 75:25.

17. The insulating enamel as claimed in claim 1, wherein a proportion of the PEO intercalated clay and the organic dispersible silica nano-particles is from 0.5:99.5 to 50:50.

18. The insulating enamel as claimed in claim 1, wherein molecular weight of PEO is between 600 and 1,000,000.

19. The insulating enamel as claimed in claim 1, wherein the organic dispersible silica nano-particles have an average size smaller than 50 nm; and the clay has an average particle size smaller than 20 μm.

20. A surge-resistant and abrasion resistant flexible insulating enamel consisting of:
resin in an amount of 12 wt % to 76 wt % per 100 wt % by weight of the enamel;
an organic solvent in an amount of 20 wt % to 80 wt % per 100 wt % by weight of the enamel;
polyethylene oxide (PEO) intercalated clay in an amount of 0.005 wt % to 16 wt % per 100 wt % by weight of the enamel; and
organic dispersible silica nano-particles in an amount of 0.995 wt % to 16 wt % per 100 wt % by weight of the enamel.
